(19) United States
(12) Patent Application Publication
(10) Pub. No.: US 2020/0055669 A1
(43) Pub. Date: Feb. 20, 2020

(54) LID PROP FOR COMMERCIAL TRASH BIN

(71) Applicant: Hodge Products, Inc., San Diego, CA (US)

(72) Inventor: Anthony A. Hodge, San Diego, CA (US)

(21) Appl. No.: 16/105,819

(22) Filed: Aug. 20, 2018

(51) Int. Cl. B65F 1/16

(52) U.S. Cl. CPC B65F 1/16; B65F 2001/1669

(57) ABSTRACT

A prop for propping the lid of a trash bin in a partially open position includes a first arm extending away from an axis in a first direction, said first direction having at least a first direction component perpendicular to said axis; a frame including a second arm connected to said first arm and extending away from said axis in a second direction, said second direction having at least a second direction component perpendicular to said axis, said frame having an elongated slot rotatably retained onto a lid rod of said container, one of said first and second arms in contact with said lid and the other of said first and second arms in contact with a rear wall of said container when said lid is in said partially open position, wherein the frame includes a lid rod access passage allowing the frame to be passed onto the lid rod.

### BACKGROUND

### Related Field

The present invention relates generally to commercial trash bins and, more specifically, to a device for propping the lids of such bins in an open position.

### Related Background

Trash bins used by commercial establishments have one or more hinged lids that can be opened to deposit trash into the bin. The bins are designed to be emptied by a trash truck. A hydraulically operated lift on the truck engages the trash bin using two forks, lifts it above the truck, and inverts the bin. The lids swing open, and the contents of the bin fall into the truck.

The lids of conventional trash bins are mounted on hinges at the rear wall of the bin adjacent the rim of the bin. When the lids are closed, they are oriented generally horizontally and perpendicular to the side walls of the trash bin. The lids can be swung open approximately 270 degrees to an orientation in which they are generally parallel to the rear wall of the trash bin. After a user has opened a lid in this manner and deposited the trash, the opened lid is out of the user's reach, and the user therefore must walk to the rear of the trash bin to close the lid. A user can avoid this inconvenience by holding on to the lid with one hand while depositing trash with the other hand, but this procedure is also inconvenient because a user may desire to use both hands to deposit the trash.

### SUMMARY

An aspect of the invention involves an economical prop for propping the lid of a trash bin in a partially open position. The prop comprises a frame having an elongated slot and a lid hinge rod access passage. The prop is mounted on a trash bin by passing the lid hinge rod access passage over a lid hinge rod of the bin so that the lid hinge rod is disposed in the slot. When mounted on a trash bin, the prop can be moved in a direction perpendicular to the axis of the lid hinge rod. The prop can thus be moved between a position in which it supports the lid in a partially open position and a position in which the lid can be swung fully open. When the prop is in the former position, two arms, one or both of which may be integral to the frame, extend generally perpendicularly away from the axis of the hinge rod. In this position, one arm contacts the rear wall of the bin and the other contacts the lid of the bin. When the prop is moved to the other position, one of the arms disengages the portion of the bin with which it was it contact. The lid can then be freely swung to any position.

Another aspect of the invention involves a prop for propping the lid of a trash bin in a partially open position comprising a first arm extending away from an axis in a first direction, said first direction having at least a first direction component perpendicular to said axis; a frame including a second arm connected to said first arm and extending away from said axis in a second direction, said second direction having at least a second direction component perpendicular to said axis, said frame having an elongated slot rotatably retained onto a lid rod of said container, one of said first and second arms in contact with said lid and the other of said first and second arms in contact with a rear wall of said container when said lid is in said partially open position, wherein the frame includes a lid rod access passage allowing the frame to be passed onto the lid rod.

One or more implementations of the aspect of the invention described immediately above includes one or more of the following: the frame includes an angled side member that terminates at a rod terminal end, which is separated from the rest of the frame a distance so as to form the lid hinge rod access passage; the frame includes a base member, a parallel member, a perpendicular side member, and an angled side member; a first bend joining the base member to the angled arm member, and the first bend includes an angle of 128-130 degrees; a second bend joining the perpendicular side member to the base member; a third bend joining the parallel member to the perpendicular side member; a fourth bend joining the angled side member to the parallel member, and the fourth bend includes an angle of 128-130 degrees; said second arm is integrally formed in one piece with said frame; and/or said first arm comprises a “U”-shaped member.

An additional aspect of the invention involves a method for propping a container lid in a partially open position, comprising disposing a prop on said container, said prop having a lid rod access passage, an elongated slot receiving a lid rod with an axis of said container therethrough, said prop having a first arm extending away from said axis in a first direction and a second arm extending away from said axis in a second direction, said first direction having a first component perpendicular to said axis, said second direction having a second component perpendicular to said axis, wherein disposing the prop on the container includes passing the lid rod onto the lid rod via the lid rod access passage; and opening said lid until said lid is in contact with one of said first and second arms and the other of said first and second arms is in contact with a rear wall of said container.

One or more implementations of the aspect of the invention described immediately above includes one or more of the following: the frame includes an angled side member that terminates at a rod terminal end, which is separated from the rest of the frame a distance so as to form the lid hinge rod access passage, and disposing the prop on the container includes passing the lid rod onto the lid rod via the lid rod access passage between the rod terminal end and the rest of the frame; ; the frame includes a base member, a parallel member, a perpendicular side member, and an angled side member; a first bend joining the base member to the angled arm member, and the first bend includes an angle of 128-130 degrees; a second bend joining the perpendicular side member to the base member; a third bend joining the parallel member to the perpendicular side member; a fourth bend joining the angled side member to the parallel member, and the fourth bend includes an angle of 128-130 degrees; said second arm is integrally formed in one piece with said frame; and/or said first arm comprises a “U”-shaped member.

The foregoing, together with other features and advantages of the present invention, will become more apparent when referring to the following specification, claims, and accompanying drawings.

### BRIEF DESCRIPTION OF THE DRAWINGS

For a more complete understanding of the present invention, reference is now made to the following detailed description of the embodiments illustrated in the accompanying drawings, wherein:

FIG. 1 is a perspective view of a trash bin lid prop;

FIG. 2 is a side elevation view, partially cut away, of a portion of a trash bin with the lid prop mounted on it;

FIG. 3 is a rear view of the structure of FIG. 2;

FIG. 4 is a view similar to FIG. 2, showing the lid prop propping the lid up;

FIGS. 5-7 are perspective views of the trash bin lid prop shown being applied to the lid hinge rod;

FIGS. 8 and 9 are a perspective view and a side elevation view of the trash bin lid shown being moved to a position generally parallel to the rear wall of the trash bin.

FIG. 10 is a perspective view of the trash bin lid prop shown applied to lids of a commercial dumpster.

### DETAILED DESCRIPTION

The subject matter described herein is taught by way of example implementations. Various details have been omitted for the sake of clarity and to avoid obscuring the subject matter. The examples shown below are directed to devices, apparatus and methods for propping open a lid of a trash container. Other features and advantages of the subject matter should be apparent from the following description.

After reading this description it will become apparent to one skilled in the art how to implement the invention in various alternative embodiments and alternative applications. However, all the various embodiments of the present invention will not be described herein. It is understood that the embodiments presented here are presented by way of an example only, and not limitation.

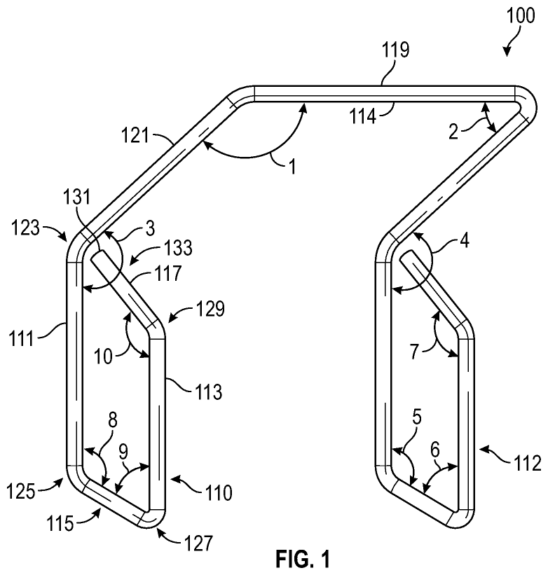

As illustrated in FIG. 1, a lid prop 100 has two elongated frame members 110 and 112, which together define a frame. A “U”-shaped arm 114 extends away from frame members 110 and 112. The frame members 110 and 112 each include a base member 111, a parallel member 113, a perpendicular side member 115, and an angled side member 117. The “U”-shaped arm 114 includes a lateral bridge member 119 and angled arm members 121. The base members 111 are joined to angled arm members 121 at first bends 123. The perpendicular side member 115 is joined to the base member 111 at second bend 125. The parallel member 113 is joined to the perpendicular side member 115 at third bend 127. The angled side member 117 is joined to the parallel member 113 at fourth bend 129. The preferred angles shown in FIG. 1 are as follows: Angles 1, 2 at 45 degrees, Angles 3, 4 at 128 to 130 degrees; Angles 5, 6 at 45 degrees; Angles 7, 10 at 128 to 130 degrees, Angles 8, 9 at 45 degrees

The angled side member 117 terminates at a rod terminal end 131 that is separated a distance from the first bend 123 so as to form a lid hinge rod access passage 133. The lid prop 100 may be made by bending a metal rod into the configuration shown.

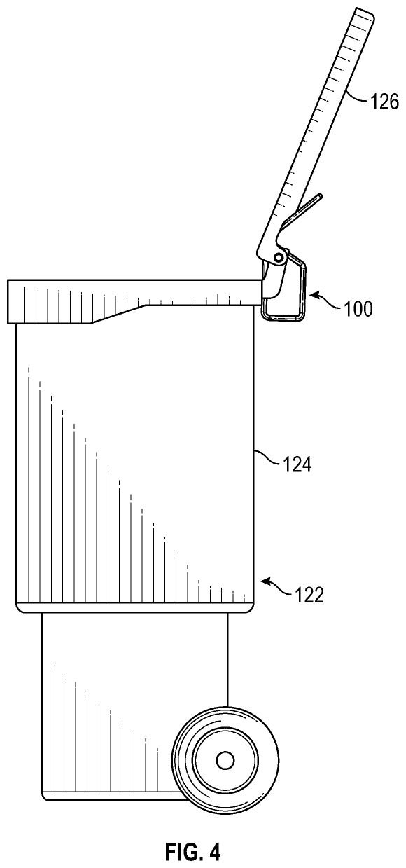

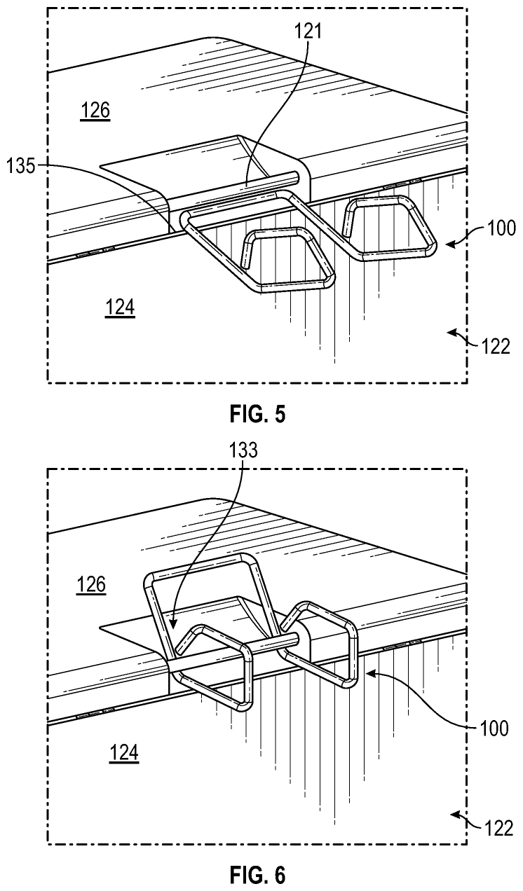

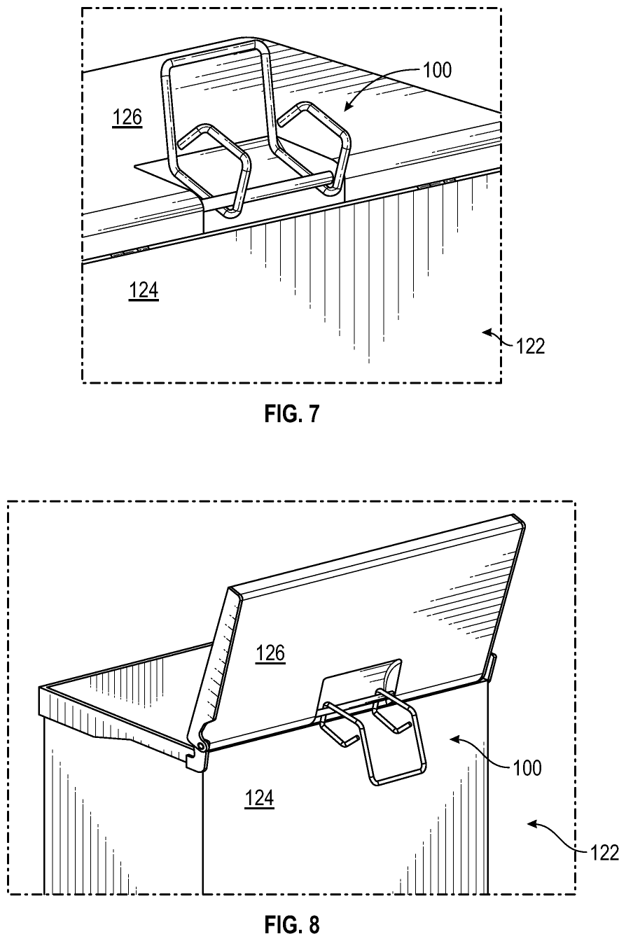

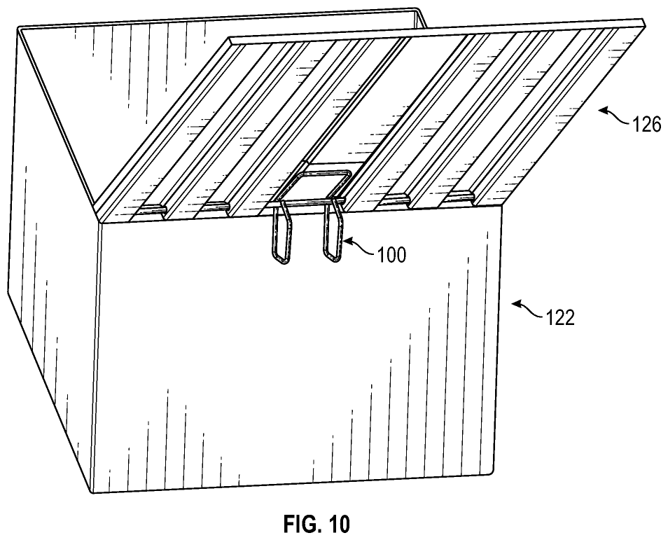

To use the prop 100, it is mounted on a residential (see FIG. 4) or commercial (see FIG. 10) trash bin 122. As shown in FIG. 5, the lateral bridge member 119 of the “U”-shaped arm 114 is first inserted between the lid hinge 121 and a top edge 135 of a rear wall 124 of the trash bin 122. The angled arm members 121 are then inserted between the lid hinge 121 and the top edge 135. The lid hinge 121 of the trash bin 122 is then received through the lid hinge rod access passage 133 of the prop 100 so that lid hinge 121 is received in the slot-like passage of the frame members 110 and 112, as illustrated in FIGS. 6 and 7. Frame members 110 and 112 have an elongated rectangular shape and together define a slot-like passage for receiving lid hinge 121. The lid hinge 121 can thus be slid in the slot-like passage in the direction of the longer dimension of frame members 110 and 112. To prevent the prop 100 from accidentally disengaging from the hinge rod 121 via the lid hinge rod access passage 133, the lid hinge rod access passage 133 may be reduced in sized or eliminated by bending the prop 100 so that the rod terminal end 131 is brought closer to the “U”-shaped rod 114 and/or first bend 123. The rod terminal end 131 may also be welded to the “U”-shaped rod 114 and/or first bend 123 to close off the lid hinge rod access passage 133, preventing the prop 100 from accidentally disengaging from the hinge rod 121.

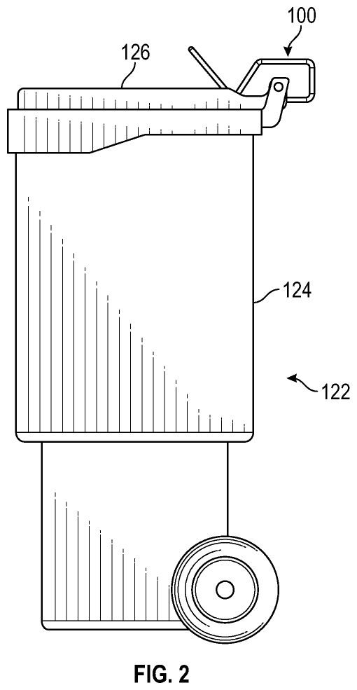

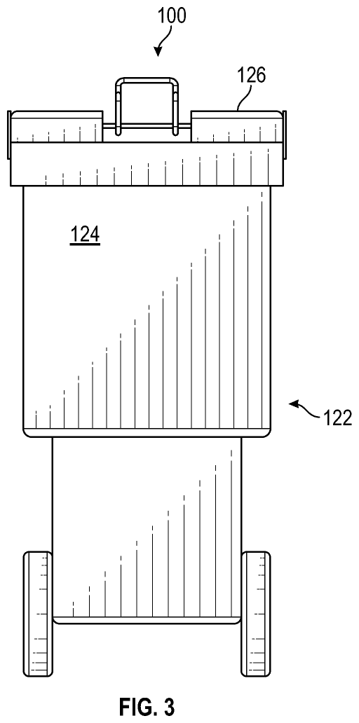

When the prop 100 is oriented in the position shown in FIG. 4, the base members 111, which comprise the elongated sides of frame members 110 and 112, contact the rear wall 124 of trash bin 122. The lid 126 of trash bin 122 can be swung open from the closed position, shown in FIGS. 2 and 3, to the partially open position shown in FIG. 4. In this partially open position, lid 26 bears against arm 114, which in turn, causes base members 111 to bear against rear wall 124. The portions of frame members 110 and 112 that extend away from hinge rod 121 in this position thus together function as a second arm. This arm and arm 114 thus pivotally support lid 126 with respect to rear wall 124 about hinge rod 121.

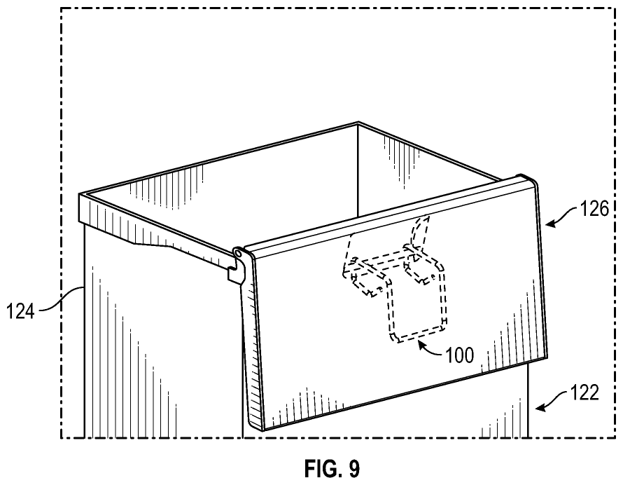

The prop 100 can be moved to the position shown in FIG. 9 to fully open the lid 126 so that the lid 126 is parallel or substantially parallel with the rear wall 124 of the trash bin 122. Momentarily swinging lid 126 to a position in which its weight does not bear against arm 114 may facilitate movement of the prop 100 to this position. Lid 126 may be swung open to the position shown in FIG. 9, in which lid 126 bears against frame members 110 and 112, and arm 114 bears against rear wall 124.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. An apparatus on a container for propping a lid of the container in a partially open position, comprising:
a first arm extending away from an axis in a first direction, said first direction having at least a first direction component perpendicular to said axis;
a frame including a second arm connected to said first arm and extending away from said axis in a second direction, said second direction having at least a second direction component perpendicular to said axis, said frame having an elongated slot rotatably retained onto a lid rod of said container, one of said first and second arms in contact with said lid and the other of said first and second arms in contact with a rear wall of said container when said lid is in said partially open position,
wherein the frame includes a lid rod access passage allowing the frame to be passed onto the lid rod.

2. The apparatus of claim 1, wherein the frame includes an angled side member that terminates at a rod terminal end, which is separated from the rest of the frame a distance so as to form the lid hinge rod access passage.

3. The apparatus of claim 1, wherein the frame includes a base member, a parallel member, a perpendicular side member, and an angled side member.

4. The apparatus of claim 3, further including a first bend joining the base member to the angled arm member, and the first bend includes an angle of 128-130 degrees.

5. The apparatus of claim 3, further including a second bend joining the perpendicular side member to the base member.

6. The apparatus of claim 3, further including a third bend joining the parallel member to the perpendicular side member.

7. The apparatus of claim 3, further including a fourth bend joining the angled side member to the parallel member, and the fourth bend includes an angle of 128-130 degrees.

8. The apparatus claimed in claim 1, wherein said second arm is integrally formed in one piece with said frame.

9. The apparatus claimed in claim 1, wherein said first arm comprises a “U”-shaped member.

10. A method for propping a container lid in a partially open position, comprising the steps of:
disposing a prop on said container, said prop having a lid rod access passage, an elongated slot receiving a lid rod with an axis of said container therethrough, said prop having a first arm extending away from said axis in a first direction and a second arm extending away from said axis in a second direction, said first direction having a first component perpendicular to said axis, said second direction having a second component perpendicular to said axis, wherein disposing the prop on the container includes passing the lid rod onto the lid rod via the lid rod access passage; and
opening said lid until said lid is in contact with one of said first and second arms and the other of said first and second arms is in contact with a rear wall of said container.

11. The method of claim 10, wherein the frame includes an angled side member that terminates at a rod terminal end, which is separated from the rest of the frame a distance so as to form the lid hinge rod access passage, and disposing the prop on the container includes passing the lid rod onto the lid rod via the lid rod access passage between the rod terminal end and the rest of the frame.

12. The method of claim 10, wherein the frame includes a base member, a parallel member, a perpendicular side member, and an angled side member.

13. The method of claim 12, further including a first bend joining the base member to the angled arm member, and the first bend includes an angle of 128-130 degrees.

14. The method of claim 12, further including a second bend joining the perpendicular side member to the base member.

15. The method of claim 12, further including a third bend joining the parallel member to the perpendicular side member.

16. The method of claim 12, further including a fourth bend joining the angled side member to the parallel member, and the fourth bend includes an angle of 128-130 degrees.

17. The method claimed in claim 10, wherein said second arm is integrally formed in one piece with said frame.

18. The method claimed in claim 10, wherein said first arm comprises a “U”-shaped member.
